(19) United States
(12) Patent Application Publication
(10) Pub. No.: US 2018/0288613 A1
(43) Pub. Date: Oct. 4, 2018

(54) AUTHENTICATION METHOD, AUTHENTICATION SYSTEM AND AUTHENTICATION DEVICES FOR AUTHENTICATING AN OBJECT

(71) Applicant: XIPHOO GMBH, Eichenau (DE)

(72) Inventor: Andreas LUIBLE, Pfalzgrafenweiler (DE)

(21) Appl. No.: 15/525,260

(22) PCT Filed: Nov. 2, 2015
(86) PCT No.: PCT/EP2015/075478

§ 371 Date: Jul. 20, 2017

(30) Foreign Application Priority Data
Nov. 11, 2014 (DE) 10 2014 222 937.5

(51) Int. Cl. H04W 12/06; H04W 12/12; H04L 9/08; H04L 9/32

(52) U.S. Cl. CPC H04W 12/06; H04W 12/12; H04L 9/0894; H04W 4/80; H04L 2209/805; H04L 2209/80; H04L 9/3226

(57) ABSTRACT

The invention relates to an authentication method, an authentication system and authentication means for authenticating an object which is fitted with an identifier, in particular with an RFID tag. In order to allow products to be protected cost-efficiently against counterfeiting, or at least to allow the existence of an unauthorized imitation to be detected, a method for authenticating an object is proposed, comprising the steps of: reading first authentication data from an identifier data store of an identifier, in particular of an RFID tag, which is attached to the object, by a read/write device designed to read data from the identifier data store and to write data into the identifier data store; providing comparative data in a comparative data store of a comparator; authenticating the identifier by comparing the first authentication data with the comparative data; generating second authentication data and storing second authentication data as new comparative data in the comparative data store and as new first authentication data in the identifier data store if the first authentication data match the comparative data.

The invention relates to an authentication method, an authentication system and authentication devices for authenticating an object which is fitted with an identifier, in particular with an RFID tag.

Product piracy, counterfeiting of products and brand piracy are terms referring to business in unauthorized imitation goods. These are produced with the aim of being confusingly similar to an original branded product, and often involves the infringement of trademark rights, or violations of regulations in competition law. Counterfeiting occurs in every industry, in particular with software, watches, clothing, medicines, automotive parts, and even complete motor vehicles. Clones are also made of spare parts for machinery and capital goods—even for aircraft.

Product piracy is a multifaceted problem. It is not only the companies affected that suffer, in the form of substantial revenue losses and damage to their reputation due to lower product quality, but also the final customers who buy a counterfeited product, because in addition to financial fraud they can endanger their health, and in the worst case even their lives, for example in the case of counterfeited drugs.

Various methods are used today to prevent product piracy. One of these methods uses RFID tags attached to the products to be protected. In order to verify the authenticity of such a product, the tag is read using a suitable RFID reader.

Toner cartridges made for commercial printers by all the major printer manufacturers, for example, are often equipped with this technology, that is to say with an RFID tag. An RFID reader installed in the printer reads the RFID tag whenever a new toner cartridge is inserted. If the reader detects that a toner cartridge does not have an RFID tag, the printer is disabled.

In applications hitherto, copy protection is generally confined to reading the identification number unique to the RFID tag, which means that the authenticity of the product is concluded from the mere presence of an RFID tag. The obvious weakness of this method is the ease with which RFID tags can be copied. When a product counterfeiter uses the same RFID tags, which anyone can purchase, on the counterfeited products, that protection is circumvented. As a consequence, this method is no longer secure.

Additional security can be provided by a method in which only known identification numbers are known to be authentic. Even with such a method, however, all that is needed in order to use a counterfeited product is to store on the RFID tag an identification number which is known to be treated as authentic by the system.

Greater security is provided by methods which use security algorithms on the RFID tag. In one such method, it is no longer possible for a tag to be copied without further ado. However, this requires a significantly more complex and therefore more expensive RFID tag and relatively complicated management of cryptographic keys. These methods, too, are no longer secure nowadays, because in the case of the symmetric methods that are common today there is still a risk of the cryptographic keys being read out. Key management security is therefore compromised, given that it is becoming easier and easier to acquire the respective technologies.

For the reasons stated above, it would be more appropriate to use asymmetric encryption techniques. However, such methods impose tough requirements regarding available energy resources, so they are difficult to implement on passive, mostly batteryless RFID tags.

The problem, therefore, is how to protect against product piracy while at the same time taking into account that the RFID tag should be designed to be as simple and cost-efficient as possible, that there should be no way of cloning the RFID tag, that there is no point in such cloning, and that a high level of security can be achieved based on asymmetric cryptography, which would preclude the risk of invasive attack.

One aim of the present invention is therefore to prevent or at least mitigate the disadvantages of prior art authentication methods and authentication systems, and to provide an authentication method, an authentication system and authentication devices for authenticating an object, which allow products to be protected cost-efficiently against counterfeiting, or which at least allow the existence of an unauthorized imitation to be detected.

One aspect of the present invention relates to a method for authenticating an object, comprising the steps of reading first authentication data from an identifier data store of an identifier, in particular of an RFID tag, which is attached to the object, by a read/write device designed to read data from the identifier data store and to write data into the identifier data store, providing comparative data in a comparative data store of a comparator, authenticating the identifier by comparing the first authentication data with the comparative data, generating second authentication data and storing second authentication data as new comparative data in the comparative data store and as new first authentication data in the identifier data store if the first authentication data match the comparative data.

According to another aspect of the invention, a system for authenticating an object is provided, comprising a read/write device designed to read first authentication data from an identifier data store for an identifier, in particular for an RFID tag, and to write second authentication data into the identifier data store of the identifier, and a comparator containing a comparative data store, wherein the system is designed to compare first authentication data with comparative data which are stored in the comparative data store to provide second authentication data and to store them as new comparative data in the comparative data store if the first authentication data match the comparative data.

Another aspect of the invention relates to a local read/write device for a system for authenticating an object, comprising a transmitter unit for sending data, a receiver unit for receiving data, a reading device which is designed to read first authentication data from an identifier data store of an identifier, in particular of an RFID tag, which is attached to an object to be authenticated, a decryption device for decrypting authentication data with a read key, a storage device for storing a read key, and a write device for writing the second authentication data as first authentication data into the identifier store of the identifier.

A further aspect of the invention relates to an alternative local read/write device for a system for authenticating an object, comprising a transmitter unit for sending data, a receiver unit for receiving data, a key generating device for generating a read key/write key pair, wherein the write key is known only to the read/write device and the read key is sent by the transmitter device to the comparator and is stored in a key storage device of the comparator, a read device which is designed to read first authentication data from an identifier store of an identifier, in particular of an RFID tag, which is attached to an object to be authenticated, an encryption device for encrypting the second authentication data with the write key if the first authentication data match the comparative data, and a write device for writing the second authentication data as first authentication data into the identifier store of the identifier.

Yet another aspect of the invention relates to a comparator for a system for authenticating an object, for comparing first authentication data from an identifier data store of an identifier, in particular of an RFID tag, which is attached to an object to be authenticated, with the comparative data, comprising a transmitter unit for sending data, a receiver unit for receiving data, a key generating device for generating a read key/write key pair, wherein the write key is known only to the read/write device and the read key is sent by the comparator to the read/write device and is stored in a key storage device of the read/write device, a key storage unit for storing a read key/write key pair, wherein the write key is known only to the comparator, an authentication data generating unit for generating second authentication data, an encryption device for encrypting the second authentication data with the write key if the first authentication data match the comparative data, and a comparative data store for storing the second authentication data as comparative data if the first authentication data match the comparative data from a comparative data store.

In the present invention, this means that, by providing comparative data in a central device, which are identical to the data provided on the identifier if the identifier is authentic, and by generating new comparative data if authentication was successful, which are stored not only on the identifier but also in the central device, a counterfeited identifier no longer has the current comparative data, at the latest after the first use of the authentic identifier, and therefore stands out as a counterfeited identifier when a comparison is made. Due to the data stored on the identifier being compared with data stored in a central device provided for that purpose, such as a server or a cloud computer, and generated anew after each comparison, and which are stored in both the central device and on the identifier, which can be an RFID tag, for example, it is impossible to counterfeit indefinitely the data stored on the identifier. In this way, the security of products protected with an identifier which uses a method according to the present invention as authentication method is enhanced. Since authentication of an identifier in accordance with the present invention requires only an identifier which is able to store data, without any further, more complex features being necessary, such an identifier is very cost-efficient.

The invention is based on the following ideas.

By using a dynamic secret between the RFID tag and an external system, it is possible to prevent data on the RFID tag from simply being copied such that a counterfeited RFID tag also acquires validity. The security of the method according to the invention is transferred entirely to an external device, which can be monitored by the manufacturer of a product, for example.

In one method according to the invention, the RFID tag and an external system share a secret, that is to say a piece of information known to both devices, for example, but in contrast to the prior art method, this piece of information does not remain the same in the method according to the invention, but is changed every time the RFID tag is read, and is thus dynamic. If a read RFID tag is recognized as authentic on the basis of its current information, a piece of information is generated which is stored not only on the RFID tag but also in the external device. The next time the RFID tag is read, it will consequently be recognized on the basis of the latter information, and a new identification is generated in turn.

The consequence of this is that, although it is possible to clone the RFID tag and the information stored on it, there is no way of recognizing whether the stored information is the current information. If the information is no longer up-to-date, the counterfeited product cannot be used and is identified as inauthentic. This idea makes it pointless to clone information on RFID tags onto counterfeited products on a large scale, because the unauthorized seller must always anticipate that the information on its products is no longer up-to-date.

It is possible with this method to use a very simple and cost-efficient RFID tag, yet still ensure a high level of protection.

For cost reasons, solutions such as those found in the prior art mostly use RFID tags that likewise have only one identification number and one memory (ISO 015693). When these RFID tags are used without the method according to the invention as described above, the disadvantage is that these tags can be copied relatively easily. So in many cases nowadays, it is not only the product itself that is copied, but also its RFID tag along with it.

As an alternative, there are RFID tags which provide security features (ISO 14443) for preventing cloning. This technology is used in fare collection cards or biometric passports, for example. The disadvantage, however, is that these RFID tags are significantly more expensive. Moreover, as soon as the security algorithms implemented on the RFID tag have been cracked, it is possible to make clones in this case also.

The need for these complex RFID tags is obviated when a method according to the invention is used, which results in significant cost savings, and it is even possible at the same time to enhance the level of security, because compromising (cracking) the encryption algorithm cannot produce useful clones of the RFID tag.

In the prior art hitherto, the attempt is also made to enhance the level of security by using appropriate asymmetric cryptographic methods. However, these are often too complex for them to be implemented with today's technology on a passive, mostly batteryless RFID tag.

Although not absolutely essential for guaranteeing security, the method according to the invention also offers a cost-efficient way of using complex asymmetric cryptographic methods, too, because use of the method can be implemented in its entirety on an external device.

On the product side, the solution presented here thus allows a simple RFID tag to be used without needing any further safeguards, and transfers the security function to an external device over which a product manufacturer, for example, preferably has full control, so that it can adjust the level of security at will. By updating the data on the RFID tag, the latter retains its “freshness” at all times, and cloning it is possible but pointless.

One modification of the embodiment of the invention described above relates to a method for authenticating an object, wherein the result of comparison is provided to the read/write device and the second authentication data are generated by a local read/write device and provided to the comparator.

In the event of the connection between the read/write device and the comparator being lost during the authentication process, this modification allows the new authentication data that are needed to be stored on the identifier, for example. This is advantageous, because in the event of the connection being lost, it is generally the case that there is no way way of storing the new data on the identifier, not even later, whereas it is simple to transmit the new comparative data to the comparator at a later time as well, once the connection has been re-established. This modification therefore makes the method less prone to malfunctions in the connection between the read/write device and the comparator.

One variant of the embodiment described above relates to a method for authenticating an object, in which the local read/write device generates the second authentication data before authenticating the first authentication data and said method, after generating the second authentication data, comprises the steps of storing the second authentication data as new first authentication data in the identifier data store by the read/write device, sending the second authentication data to the comparator, and storing the second authentication data as new comparative data in the comparative data store if the first authentication data match the comparative data.

One advantage of this variant is that the new data that have been generated are stored on the identifier in such a case, even when a connection between the read/write device and the comparator breaks down before a result of result of comparison has been sent to the read/write device. The data are always stored anew in the identifier, regardless of the result of authentication, and the data in the comparative data store are also updated only if authentication is successful. This likewise results in authentication of the identifier being less prone to malfunctions in the communication link between the read/write device and the comparator, yet it is possible at the same time to ensure the security of authentication.

Another variant of the embodiment described above relates to a method for authenticating an object, in which the local read/write device generates the second authentication data after authenticating the first authentication data, and said method further comprises the steps of providing a signal by the comparator if the first authentication data match the comparative data, sending the signal to the read/write device, generating the second authentication data and storing the second authentication data as new first authentication data when the signal is received by the read/write device, and storing the second authentication data as new comparative data in the comparative data store of the comparator.

Due to the comparator sending only one signal after authentication, notifying the read/write device of the result of authentication, and to the read/write device only then generating new data and storing them on the identifier, it is possible to avoid unnecessary writing into the identifier, while at the same time reducing the susceptibility of authentication to malfunctions in the communication link between the read/write device and the comparator. Secure authentication of the identifier is thus ensured.

Another modification relates to an authentication method as described above, in which the second authentication data are generated by the comparator, and said method further comprises the step of sending the second authentication data to the local read/write device if the first authentication data match the comparative data.

Such a modification, in which the new data are generated by the comparator and the read/write device merely provides the means for reading and writing the data into the identifier, as well as the communication link with the comparator, allows the read/write device to be a simple and cost-efficient one, since no additional elements are needed in order to carry out the method.

Another modification relates to an authentication method as described above, in which the authentication data and the comparative data are encrypted.

Encrypting the data ensures that unauthorized use of the stored and generated data is not possible without the key required for reading or writing. Secure authentication of the identifier is thus ensured in this embodiment also.

One variant relates to a authentication method, as described above, in which the authentication data are encrypted and the method further comprises the steps of decrypting the first authentication data in the comparator with a first key, comparing the decrypted first authentication data with the comparative data and generating second authentication data if the first authentication data match the comparative data, encrypting the second authentication data with a second key which is known only to the comparator, providing the encrypted second authentication data by the comparator and storing the encrypted second authentication data as new first authentication data in the identifier data store of the identifier.

Using an authentication method in which only the comparator can encrypt and also decrypt the data stored on the identifier ensures that only the comparator knows the data that are stored on the identifier. On this basis, it is also possible for sensitive data which allow better tracking of the identifier but which are not to be read by unauthorized entities, to be used as comparative data.

Another option relates to an authentication method as described above, in which the first key matches the second key or in which the first and the second key form a write key/read key pair.

By providing a first key that matches the second key, the encryption system is kept as simple as possible in order to lower the costs for the system. When different keys are used for reading, i.e., for decrypting, and for writing, i.e., for encrypting, a high level of authentication security is guaranteed.

Another modification relates to an authentication method as described above, in which the authentication data are encrypted and the method further comprises the steps of generating a write key/read key pair by the comparator, sending the read key to the read/write device, decrypting the first authentication data in the read/write device with the read key, sending the unencrypted first authentication data from the read/write device to the comparator, comparing the decrypted first authentication data with the comparative data and generating second authentication data in the comparator if the first authentication data match the comparative data, encrypting the second authentication data in the comparator with the write key, sending the encrypted second authentication data to the read/write device, and storing the encrypted second authentication data as new first authentication data in the identifier data store.

This modification allows the read/write device to read the data stored on the identifier and to send the unencrypted data to the comparator, with only the comparator being able to encrypt the new data, thus ensuring that only those data which were generated with the write key/read key pair known to the comparator can be read. This has the advantage of allowing the read/write device to read the encrypted data and thus to obtain information from the encrypted data, such as the last access date or the like, while nevertheless guaranteeing a high level of security for correct authentication.

One variant relates to an authentication method as described above, in which the read key is provided in the read/write device.

Providing the read key in the read/write device without requiring the read key to be sent ensures that only authorized read/write devices obtain access to the encrypted data, thus improving the security of the authentication method.

Another modification relates to an authentication method as described above, in which the authentication data are encrypted and the method further comprises the steps of generating a write key/read key pair by the read/write device, sending the read key to the comparator, decrypting the first authentication data in the comparator with the read key, which is stored in a read key store of the comparator, comparing the decrypted first authentication data with the comparative data and generating second authentication data if the first authentication data match the comparative data, sending the unencrypted second authentication data to the local read/write device, encrypting the second authentication data with the write key which is known only to the read/write device, and storing the encrypted second authentication data as new first authentication data in the identifier data store.

Generation of the write key/read key pair by the read/write device further increases the security of the authentication method, since only data which have been generated with the respective key pair can also be encrypted correctly by the comparator.

Another modification relates to an authentication method as described above, in which the authentication data comprise identity data which allow clear identification of the identifier, and test data which are compared with the comparative data of the identifier, with new test data being provided if the identity data and the test data match the comparative data.

This modification allows an identifier to be clearly identified by the identity data, as the identity data are immutably associated with the identifier. According to the method described above, however, the test data are always generated anew and stored. In this way, it is possible to recognize an identifier, for example, that has previously failed authentication.

One variant relates to an authentication method for authenticating an object, as described above, in which the test data are encrypted according to one of the aforementioned methods and the identity data are unencrypted.

This variant simplifies reading the identification and allows authentication of an identifier whose identification data are stored, for example, in a list of known counterfeited identifiers, to be discontinued immediately, without any further encryption or decryption steps being performed. This secures the system and the encryption device against any unauthorized access or queries, which means the authentication method itself is also made secure.

Another variant relates to an authentication method as described above, in which the test data comprise at least one of the following: date; position; random numbers; Unique Identification Number (UID) of the identifier data store, in particular of the RFID tag.

Another modification relates to an authentication method as described above, in which the comparator compares the first authentication data and the comparative data in the local read/write device and the comparative data are stored in an external storage device, said method further comprising the steps of requesting the comparative data from the external storage device by the read/write device, sending the comparative data by the external storage device to the read/write device, comparing the first authentication data with the sent comparative data by the comparator in the local read/write device, providing second authentication data by the read/write device if the first authentication data match the sent comparative data, sending the provided second authentication data to the external storage device, and storing the second authentication data as new comparative data in the comparative data store of the external storage device.

Due to the data being compared in the read/write device, in this modification, it is also possible to perform the comparison if the communication link with the storage device is lost after sending the comparative data. The guarantees an effective authentication method, even when the communication link between the read/write device and the storage unit is unstable, for example. Secure authentication is thus made possible. The storage device, which is mostly external, is greatly simplified as well, in that it no longer contains a comparator and thus becomes more cost-efficient.

In the following, the present invention shall be illustrated and described with reference to the embodiments shown in the Figures, in which

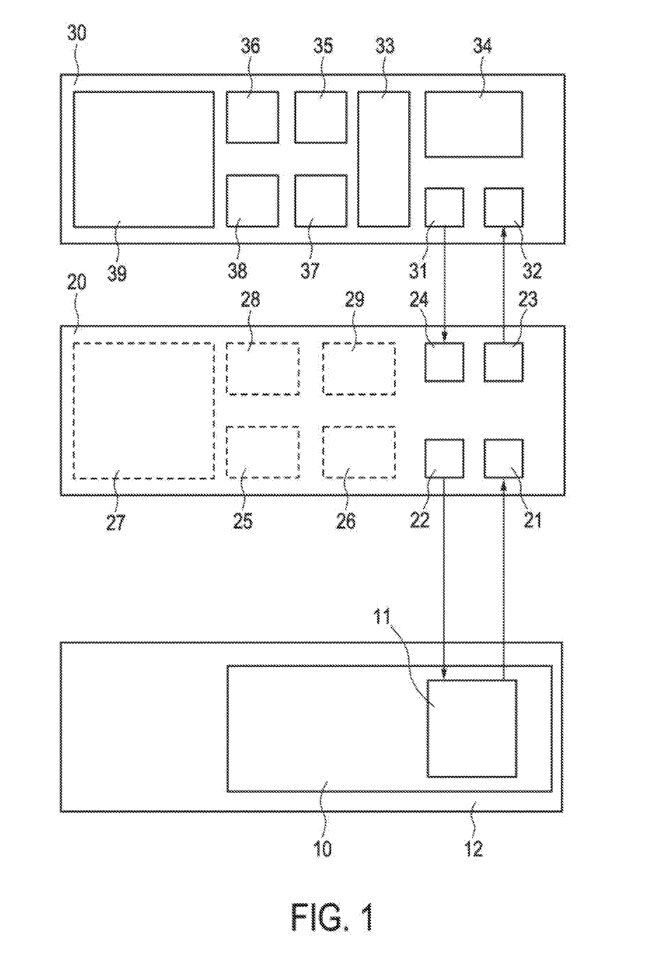

FIG. 1 shows a schematic view of an embodiment of a system which is able to carry out the method according to the invention.

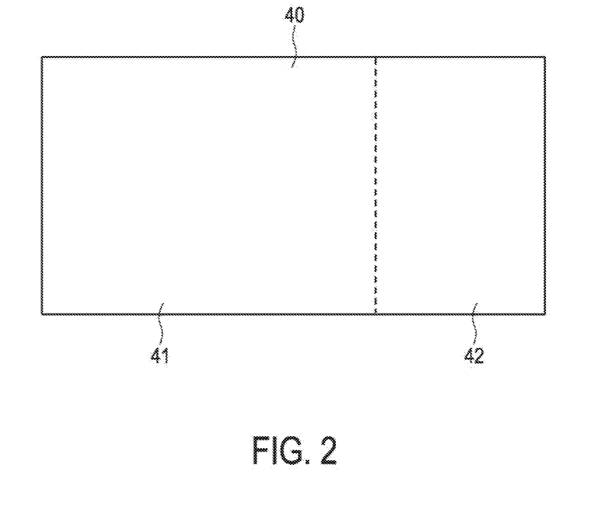

FIG. 2 shows a schematic view of a preferred composition of the authentication data.

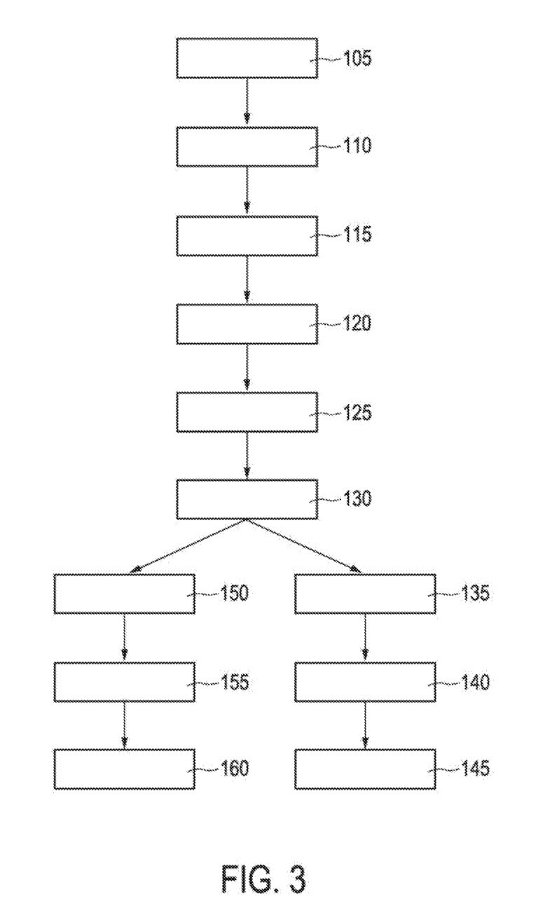

FIG. 3 shows a schematic flow diagram of an embodiment of a method according to the invention.

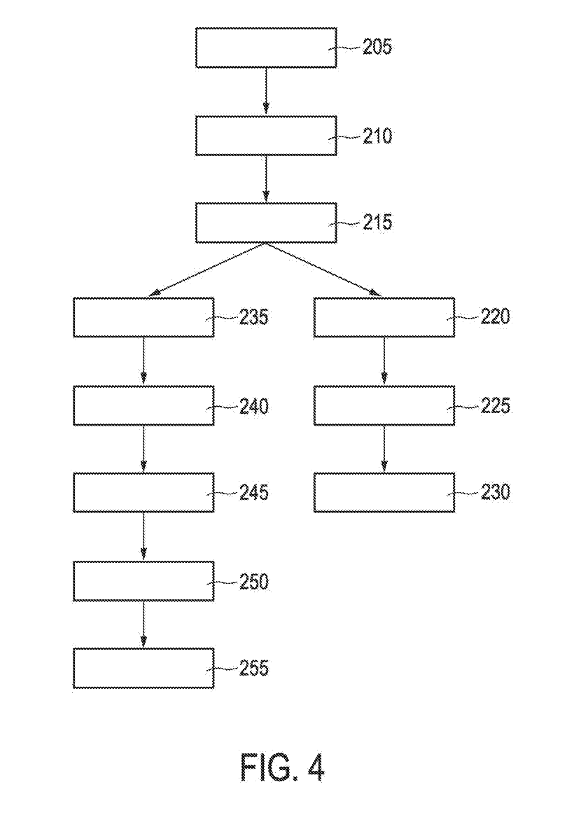

FIG. 4 shows a schematic flow diagram of another embodiment of a method according to the invention.

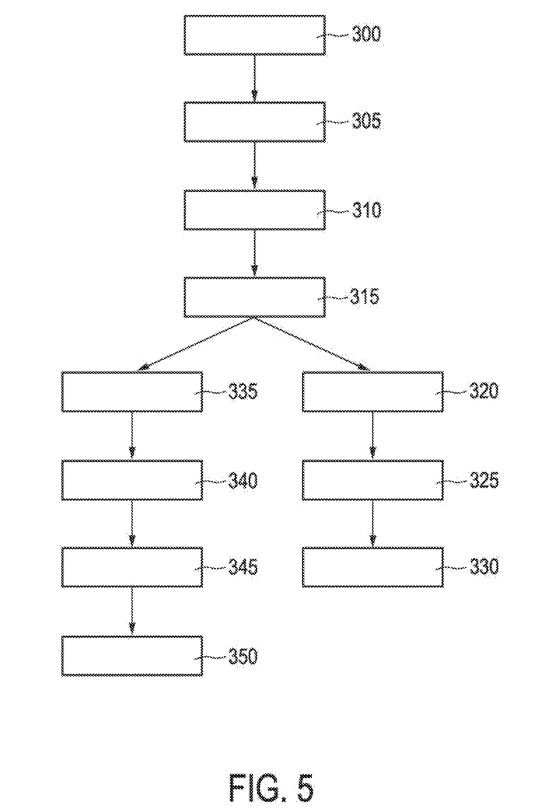

FIG. 5 shows a schematic flow diagram of another embodiment of a method according to the invention.

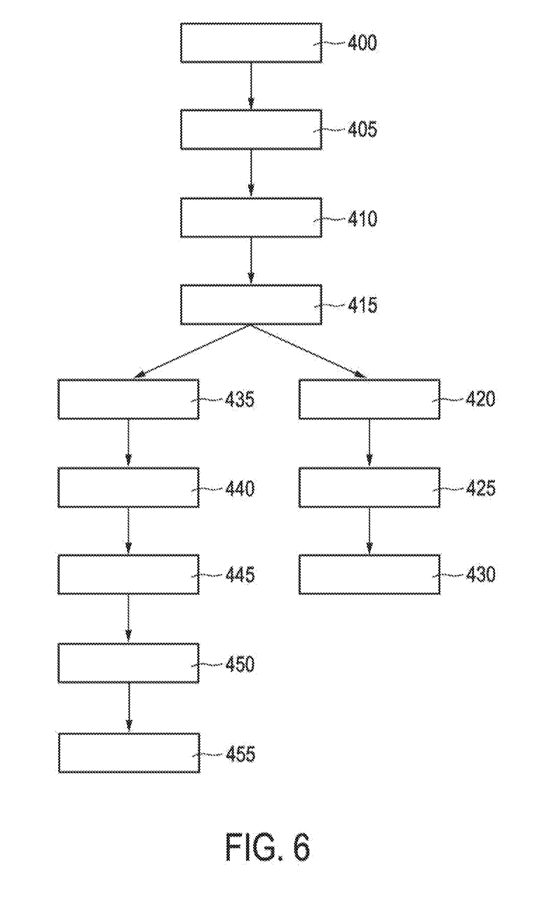

FIG. 6 shows a schematic flow diagram of another embodiment of a method according to the invention.

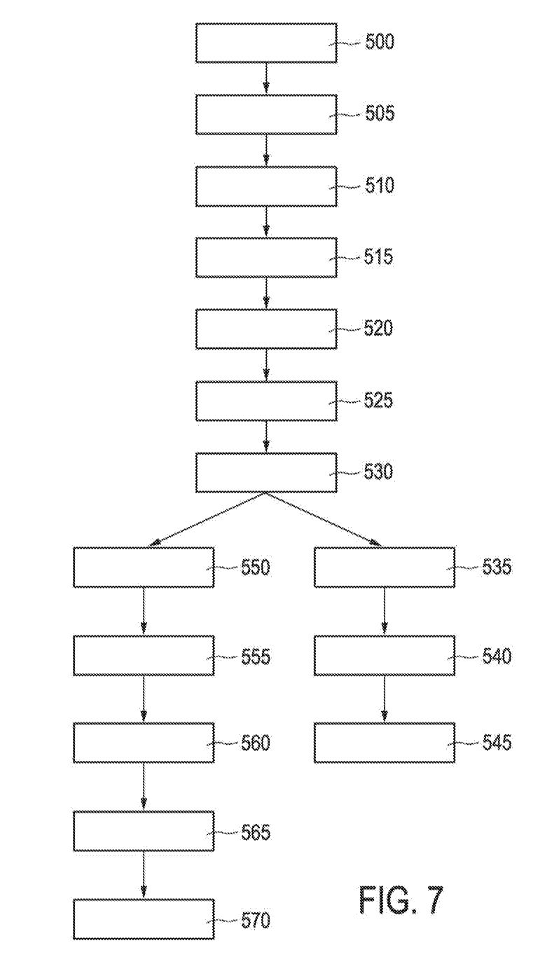

FIG. 7 shows a schematic flow diagram of another embodiment of a method according to the invention.

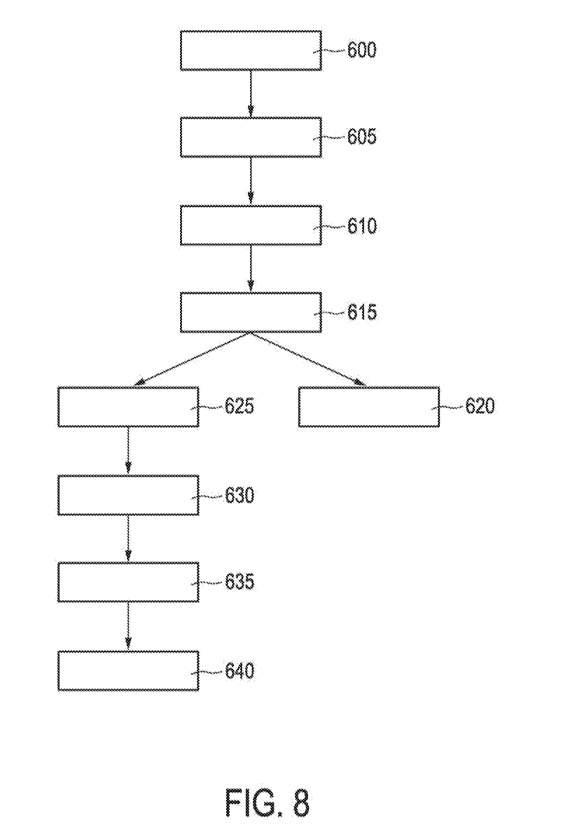

FIG. 8 shows a schematic flow diagram of another embodiment of a method according to the invention.

FIG. 1 shows a schematic view of an embodiment of a system which is able to carry out a method according to the present invention. An identifier 10, which in this embodiment is an RFID tag, although it can also take other suitable forms, includes an identifier data store 11. The identifier is attached to an object 12 in such a way that a read/write device 20 can easily read identifier data store 11. In practical implementation, object 12 is a DVD, for example, or an article of clothing or any other product to be secured against counterfeiting.

In this embodiment, read/write device 20 comprises a reader unit 21 for reading data from identifier data store 11 of identifier 10, and a writer unit 21 for writing data into identifier data store 11 of identifier 10. The read/write device also has a transmitter unit 23 for sending data to an external device and receiver unit 24 for receiving data from an external device. In practical implementation, the read/write device may be accommodated in a printer for reading an inserted toner cartridge. In other embodiments, the read/write device could also be a smartphone, for example, or a scanner in a department store or the like.

In this embodiment, the system also includes a comparator 30 comprising a receiver unit 32 for receiving data and a transmitter unit 31 for sending data. Comparator 30 includes a comparative data store 34 for storing comparative data. In this preferred embodiment, comparator 30 also comprises an authentication unit 33 and in addition an authentication data generating unit 35 for generating authentication data, a decryption unit 36 for decrypting encrypted data, an encryption unit 37 for encrypting data, a key pair generating unit 38 for generating a write key/read key pair, and a key storage unit 39.

In this embodiment, comparator 30 is a cloud computer system. Authentication unit 33, authentication data generating unit 35, decryption unit 36, encryption unit 37 and key pair generating unit 38 are realized in this embodiment as units of a computer program that is executed on a suitable computer chip.

When the method according to the invention is carried out, the authentication data are read from identifier data store 11 of identifier 10 by read/write device 20 using reader unit 21. Conversely, data can also be written into the identifier data store 11 of identifier 10 using writer unit 22. This occurs because identifier 10 is an RFID tag having known RFID technology for reading and writing. The authentication data are sent from the transmitter unit 23 via a connection to the receiver unit 32 of comparator 30. Conversely, the authentication data are sent from the transmitter device 31 of comparator 30 to the receiver unit 24 of read/write device 20. In this embodiment, the connection between the devices is an Internet connection, but in other embodiments it could also be some (other) cable connection, for example, or a WLAN connection, a Bluetooth connection or some other wireless connection.

Another embodiment of the read/write device shall now be described in the following, again with reference to FIG. 1. In this alternative embodiment, read/write device 20 further comprises a decryption unit 25 for decrypting encrypted data. The read/write device additionally comprises an authentication data generating unit 26 for generating authentication data, a display 27 for displaying an authentication result and a key pair generating unit 28 for generating a new read key/write key pair. Thus, in this embodiment, the read/write device can also generate authentication data and decrypt data.

In yet another alternative embodiment, likewise shown in FIG. 1, read/write device 20 additionally includes an authentication unit 29 for authenticating identifier 10. In this embodiment, the identifier is authenticated by read/write device 20. A simple, external storage device (not shown here) is used to store the comparative data.

The functions of the additional units used in these alternative embodiments of read/write device 20, such as decryption unit 25, authentication data generating unit 26, key pair generating unit 28 and authentication unit 29, are performed in this embodiment by a computer chip on which an equivalent computer program runs.

FIG. 2 shows a schematic view of a preferred composition of authentication data 40. In a preferred embodiment, authentication data 40 are composed of test data 41 and identity data 42. In the preferred method, test data 41 are replaced again and again, whereas identity data 42 are uniquely assigned to a particular identifier 10 and are kept the same at all times. Identity data 42 may be identity numbers belonging to a particular RFID tag, for example. Test data 41 could also include, for example, a date, a position, random numbers or also the Unique Identification Number (UID) in addition. In a method according to the invention, test data 41 are provided anew whenever the comparative test data stored under identity data 42 in the comparative data store 34 match test data 41. In a preferred embodiment, this process can also be described as a comparison between authentication data 40 composed of identity data 42 and test data 41, and comparative data composed of identity data and comparative test data, with only test data 41 and the comparative test data being changed whenever new authentication data 40 are provided.

FIG. 3 shows a schematic flow diagram of an embodiment of an inventive method 100 for authenticating an object. In a first step 105, the first authentication data are read out from identifier data store 11 of identifier 10 by read/write device 20. In step 110, the first authentication data are then sent from the read/write device to the comparator.

In step 115, second authentication data are generated in read/write device 20 with the aid of authentication data generating unit 26, namely before the comparator has verified the authenticity of the first authentication data. In step 120, the second authentication data are then written as new first authentication data into identifier data store 11 of identifier 10 by read/write device 20. At that point in time, it is not yet known whether the identifier is in fact authentic.

In one modification of this embodiment, identifier 10 could refrain from releasing the first authentication data for reading until identifier 10 receives new authentication data from read/write device 20. In that case, step 115 would firstly be carried out, followed by step 120, and only then would step 110 be carried out. Although this alternative method requires corresponding logic in identifier 10 and additional associated costs, it has the advantage that cloning the data of identifier 10 is possible only if new data are stored on identifier 10. If an attempt is made to counterfeit identifier 10, the original identifier 10 would be rendered unusable, since it would be impossible for a counterfeiter to store the correct new data on both identifier 10 and comparator 20. Simply copying identifier 20 is therefore rendered pointless.

In step 125 that follows, second authentication data generated by read/write device 20 are sent to comparator 30. In authentication unit 33, comparator 30 compares the first authentication data with the comparative data which are read out from comparative data store 34. If the first authentication data do not match, the method continues with step 135. In step 135, comparator 30 sends a signal to read/write device 20, containing the information that authentication has failed and that the identifier is therefore inauthentic. In step 140, read/write device 20 then recognizes identifier 10 as being non-authenticated and denies it any use of the product 12 bearing identifier 10. If a display 27 is available, read/write device 20 outputs the authentication result on display 27. In step 145, the identity data 42 of the identifier are then marked as counterfeited in the comparative data store 34 of comparator 30. The marked data could be read out, for example to obtain information about counterfeited identifiers in circulation, and to inform any customers affected, for example, or to analyze data from the identifier so as to obtain information about where a counterfeited product with a false identifier has been used, for example.

If the first authentication data match the comparative data in step 130, the identifier is authentic and the method continues with step 150. In step 150, comparator 30 stores the previously received second authentication data as new comparative data in comparative data store 34, so the authentication data stored in identifier data store 11 of identifier 10 again match the comparative data.

In step 155, comparator 30 sends a signal to read/write device 20, containing the information that authentication was successful and that the identifier is therefore authentic. In step 160, read/write device 20 then releases object 12 bearing identifier 10 for use, and shows the result on display 27 if such a display 27 is available.

This inventive method has the advantage that, if the connection between read/write device 20, which is located, for example, in a department store where a user would like to buy the object, and comparator 30, which can be a manufacturer's server, is lost during authentication, the identifier can still store the new authentication data. It might not be possible to use the object at the time the connection is lost, but since it is easy for the new authentication data to be sent later from read/write device 20 to comparator 30 as soon as a connection has been re-established, the object can continue to be used at any time if it is authentic.

FIG. 4 shows a schematic flow diagram of an alternative embodiment of a method 200 according to the invention for authenticating an object.

In step 205, read/write device 20 reads the first authentication data from identifier data store 11 of identifier 10. After that, in step 210, read/write device 20 sends the first authentication data to comparator 30.

In step 215, authentication unit 33 compares the first authentication data with the comparative data read from comparative data store 34. If the first authentication data do not match the comparative data a signal containing the information that authentication failed is sent to read/write device 20 in step 220. After receiving that signal, read/write device 20 prohibits any use of the object bearing the identifier and outputs the result of authentication on display 27 if such a display 27 is available. Comparator 30 then marks the identity data 42 in comparative data store 34 so that identifier 10 is immediately detected as a counterfeited identifier, for example when subsequently scanned.

If authentication in step 215 is successful, that is to say if the first authentication data match the comparative data, comparator 30 sends a signal to that effect to read/write device 20 in step 235. In step 240, read/write device 20 then generates second authentication data in authentication data generating unit 26 and in step 245 sends the second authentication data to the comparator. In step 250, the second authentication data are then stored as new comparative data in comparative data store 34 by comparator 30. In step 255, which can also be carried simultaneously with step 250, the second authentication data are then written by read/write device 20 into identifier data store 11 of identifier 10.

This embodiment has the same advantages as the embodiment previously described, but it could additionally prevent read/write device 20 from consuming energy unnecessarily in order to generate new authentication data if identifier 10 is not authentic.

In another embodiment according to the invention, which is shown in FIG. 5, the second authentication data are generated in comparator 30. To that end, the first authentication data are read from identifier data store 12 of identifier 10 by read/write device 20 in step 300 and are sent to comparator 30 in step 305.

In step 310, authentication unit 33 reads the comparative data belonging to the identifier from comparative data store 34 and compares them in step 315 with the first authentication data. If the comparison shows that the data do not match, the identity data 42 of identifier 10 are marked in comparative data store 34 in step 320. In step 325, comparator 30 sends a signal, containing the information that authentication has failed, to read/write device 20. In step 330, the read/write device then prohibits any use of object 12 bearing identifier 10, if necessary, and shows the result of authentication on display 27 is such a display 27 if available.

If it is established in step 310 that the identifier is authentic, because the first authentication data match the comparative data, comparator 30 generates second authentication data in an authentication data generating unit 35 in step 335. The second authentication data are then stored in comparative data store 34 of comparator 30 in step 340 and are sent to read/write device 20 in step 345. Read/write device 20 then writes the second authentication data as new first authentication data into identifier data store 11 of identifier 10 in step 350 and where relevant allows use of object 12 bearing identifier 10. If a display 27 is available, read/write device 20 outputs the result of authentication on display 27.

This embodiment has the advantage that the read/write device can be kept very simple and need only comprise reader unit 21 and writer unit 21 for reading and writing data from identifier 10, and transmitter unit 23 and receiver unit 24 for forwarding and receiving the data, respectively. In this way, the costs for the read/write device are reduced.

In another embodiment of the invention, authentication data 40 could be encrypted. Identity data 42 and also test data 41 could be encrypted, or only test data 41 are encrypted and identity data 42 remain unencrypted.

Such an embodiment according to the invention, in which the data are encrypted, is shown schematically in FIG. 6. In step 500, the encrypted first authentication data are read from identifier data store 11 of identifier 10 by read/write device 20 and sent to comparator 30 in step 405.

In step 410, the first authentication data are decrypted by decryption unit 36 of the comparator using a first key. In one embodiment, the first key could be a read key which is only suitable for decrypting, i.e., for reading the data. Such a key would be a generally known public key of an asymmetric encryption device, for example. In the next step, step 415, the decrypted first authentication data are compared with the comparative data from comparative data store 34 in authentication unit 33. If authentication fails, the method continues with steps 420 to 430, which correspond to steps 320 to 330 from the method shown in FIG. 5.

If authentication is successful in step 410, comparator 30 generates second authentication data in authentication data generating unit 35 in step 435 and stores the second authentication data as new comparative data in comparative data store 34 in step 440. After that, the comparator encrypts the second authentication data using a second key in an encryption unit 37. In one embodiment, the second key could match the first key, so that a symmetrical encryption method is used, in which the key may be known only to the comparator, in order to ensure that encryption is secure. This method has the advantage that it is very easy to implement. However, a higher level of security for the encrypted data is provided when an asymmetric encryption technique is applied. For that reason, the second key in another preferred embodiment is a write key which is only capable of encrypting, i.e., writing the data, and forms a unique write key/read key pair in combination with a read key. In this case, the write key could be a private key, for example, which is known to comparator 30 only.

In step 445, comparator 30 sends the encrypted second authentication data to read/write device 20, which stores the encrypted second authentication data as first authentication data in identifier data store 11 of identifier 10 in step 450. In step 455, if applicable, read/write device 20 allows object 12 bearing identifier 10 to be used and/or shows the result of authentication on display 27.

This embodiment has the advantage that only one device, which knows the write key, is able to write meaningful data into the identifier, thus providing additional security against counterfeits of the identifier.

In another embodiment, it is possible that the write key is a generally known key and that the read key is known to comparator 30 only. This has the advantage that sensitive data, such as local coordinates or user data, can be used as authentication data without having to fear any abuse of the data by third parties. Even when there is an unsecure connection between read/write device 20, which can be in a shop, for example, and comparator 30, which can be a manufacturer's server, the data can be securely transmitted because only comparator 30 can decrypt the encrypted data.

Another embodiment of the present invention is shown schematically in FIG. 7. In this method according to the invention, a write key/read key pair is generated in step 500 by comparator 30 in key pair generating unit 38. In step 505, the encrypted first authentication data are read from identifier data store 11 of identifier 10 by read/write device 20, and a signal is sent to comparator 30. Comparator 30 then sends the read key to read/write device 20 in step 510.

In step 520, read/write device 20 decrypts the first authentication data with the received read key in decryption unit 25 and sends the decrypted first authentication data to comparator 30 in step 525.

In its authentication unit, the comparator compares, in step 530, the unencrypted first authentication data with the comparative data stored in comparative data store 34. If authentication fails, the method continues with steps 535 to 545, which correspond to steps 320 to 330 from the method shown in FIG. 5.

If authentication is successful in step 530, the second authentication data are generated by authentication data generating unit 33 of comparator 30 and in step 555 are stored as new comparative data in comparative data store 34. After that, in step 560, the second authentication data are encrypted with the new write key by encryption unit 37 of comparator 30, and the encrypted second authentication data are sent to read/write device 20 in step 565. In step 570, read/write device 20 writes the encrypted second authentication data into identifier data store 11 of identifier 10 and allows use of object 12, to which identifier 10 is attached, and/or displays the result of authentication on a display 27.

This embodiment has the advantage that read/write device 20 can also decrypt the authentication data and thus can use any information stored therein, for example to discover something about the customer's behavior.

Alternatively, the read key of the read key/write key pair could also be already stored on read/write device 20 in this embodiment. In that case, the same read key would always be used and the read key would not have to be sent in step 505. This enhances security if it is known that a connection between read/write device 20 and comparator 30 might not be secure.

In another modification of this embodiment, the read key/write key pair could be newly generated every time identifier 10 is read. Since the read key could be read by unauthorized third parties via a potentially unsecure connection after it has been sent, a new write key/read key-pair is then generated in this embodiment so that the unauthorized third party could only read a single item of information at most, but not any subsequent new information generated using a new key pair. The security of the data is thus protected, while at the same time allowing the authentication data to be analyzed by read/write device 20.

In another alternative embodiment, the write key/read key pair could also be generated by read/write device 20 in a key pair generating unit 28. Read/write device 20 could then send the read key to comparator 30. Comparator 30 can decrypt the authentication data with the read key and store the read key in key storage unit 39.

This embodiment has the advantage that the first authentication data can be sent in encrypted form, and only if correctly authenticated are the second authentication data sent in unencrypted form. This ensures that a third party cannot request the first authentication data in unencrypted form.

FIG. 8 shows in schematic form and by way of example a flow diagram of another embodiment, in which read/write device 20 compares the first authentication data with the comparative data. In step 600, the read/write device requests the comparative data from an external storage device. The external storage device sends the comparative data to read/write device 20 in step 605. In step 610, read/write device 20 reads the first authentication data from the identifier data store 11 of identifier 10. In step 615, authentication unit 29 of read/write device 20 compares the first authentication data with the comparative data.

If the comparative data do not match the first authentication data, the read/write device outputs the result of authentication in step 620 on display 27, if available, and blocks object 12 bearing identifier 10 from further use.

If authentication in step 615 is successful, read/write device 20 generates second authentication data in an authentication data generating unit 26 in step 625. The second authentication data are sent by read/write device 20 to the external storage device in step 630 and are stored in the external storage device in step 635.

In step 640, the second authentication data are written by read/write device 20 into identifier data store 11 of identifier 10.

This embodiment has the advantage that the external storage device can be kept very simple. For example, it could be a simple external hard disk, as the comparison is carried out in the read/write device. That keeps costs for a user low, since all that is necessary is to procure a suitably equipped device, and the method can also be performed locally, for example by using an external hard disk, and without requiring access to an external server.

The embodiments described above could be carried out with the aid of proven technologies, in which the products to be protected are fitted with RFID tags. In order to verify the authenticity of the product in such an example, the RFID tag is read using a suitable reader, for example a smartphone, and the data thus read are transmitted by a radio link to a server, for example to a cloud computer. In this embodiment, the server software checks the transmitted data against data in a database and communicates a positive or negative result back to the reader. Finally, the reader shows the result to the user.

This embodiment according to the invention is based on the RFID tag containing additional data which are updated at each reading, besides the information unique to it. These additional data are programmed into the RFID tag before it is applied. They include data, for example, such an identification number, a date, a time, a time zone, URLs, a place, etc. These data are updated every time they are read. So if authentication is positive, the reader receives not only the result of authentication, but also new data which the reader programs into the memory of the RFID tag. This does not happen if the result of authentication is negative, and in one embodiment, for example, the RFID tag is marked as invalid in the database.

To protect these data from being copied, they are programmed in encrypted form into the RFID tag, in a preferred embodiment of the present invention. To that end, the original data are encrypted by the cloud computer software using an asymmetric cryptographic algorithm and a secret cryptographic key, for example a private key.

These encrypted data are then transmitted and programmed into the RFID tag. In this embodiment, said data cannot be read unless the user is in possession of the cryptographic key. However, even if someone possesses the cryptographic key for decrypting the data, for example a public key, this does not compromise security in this preferred embodiment.

This preferred embodiment prevents anyone from generating these data, because only the cloud computer knows the algorithm and the cryptographic key, for example the private key. This ensures that there is no point in cloning RFID tags in order to circumvent the protective mechanism. In other words, security is not implemented on the RFID tag, but only in the cloud. By definition, cryptographic attacks on the RFID tag no longer make sense.

This also means that, despite the high level of security, it is possible in one preferred embodiment to use a simple RFID tag (ISO 15693), because no additional security is needed on the RFID tag.

Thus, one of the advantages of the preferred embodiment is that, despite using a very simple, inexpensive RFID tag based on the ISO 15693 standard, it is pointless to clone the RFID tags. Clones of an original tag lose their validity the first time the original or the clone is read. Generic manufacturing of the RFID tags is not possible, either, because the data stored on the RFID tags are encrypted in the preferred embodiment and can only be generated by the person who possesses the respective cryptographic key, for example a private key. In the preferred embodiment, however, the data can nevertheless be decrypted, for example by the reader device, with the aid of the public cryptographic key, for example a public key, in order to obtain information offline.

In one preferred embodiment, the security of the solution thus resides entirely in the cloud, so it cannot be attacked via the RFID tag, can be controlled from a central location at all times and can be updated whenever necessary.

1. A method for authenticating an object, comprising the steps of:
reading first authentication data from an identifier data store of an identifier, in particular of an RFID tag, which is attached to the object, by a read/write device designed to read data from the identifier data store and to write data into the identifier data store;
providing comparative data in a comparative data store of a comparator;
authenticating the identifier by comparing the first authentication data with the comparative data;
generating second authentication data;
storing said second authentication data as new comparative data in the comparative data store and as new first authentication data in the identifier data store if the first authentication data match the comparative data.

2. The method according to claim 1, wherein the result of comparison is provided to the read/write device and the second authentication data are generated by a local read/write device and provided to the comparator.

3. The method according to claim 2, wherein the local read/write device generates the second authentication data before authenticating the first authentication data and said method, after generating the second authentication data, comprises the following steps:
storing the second authentication data as new first authentication data in the identifier data store by the read/write device;
sending the second authentication data to the comparator;
storing the second authentication data as new comparative data in the comparative data store if the first authentication data match the comparative data.

4. The method according to claim 2, wherein the local read/write device generates the second authentication data after authenticating the first authentication data and said method further comprises the steps of:
providing a signal by the comparator if the first authentication data match the comparative data;
sending the signal to the read/write device;
generating the second authentication data and storing the second authentication data as new first authentication data when the signal is received by the read/write device; and
storing the second authentication data as new comparative data in the comparative data store of the comparator.

5. The method according to claim 1, wherein the second authentication data are generated by the comparator and said method further comprises the step of sending the second authentication data to the local read/write device if the first authentication data match the comparative data.

6. The method according to claim 1, wherein the authentication data and the comparative data are encrypted.

7. The method according to claim 1, wherein the authentication data are encrypted and said method further comprises the steps of:
decrypting the first authentication data in the comparator with a first key;
comparing the decrypted first authentication data with the comparative data and generating second authentication data if the first authentication data match the comparative data;
encrypting the second authentication data with a second key which is known only to the comparator and providing the encrypted second authentication data by the comparator;
storing the encrypted second authentication data as new first authentication data in the identifier data store of the identifier.

8. The method according to claim 7, wherein the first key matches the second key or wherein the first and the second key form a write key/read key pair.

9. The method according to claim 1, wherein the authentication data are encrypted and said method further comprises the steps of:
generating a write key/read key pair by the comparator;
sending the read key to the read/write device;
encrypting the first authentication data in the read/write device with the read key;
sending the unencrypted first authentication data from the read/write device to the comparator;
comparing the encrypted first authentication data with the comparative data and generating second authentication data in the comparator if the first authentication data match the comparative data;
encrypting the second authentication data in the comparator with the write key;
sending the encrypted second authentication data to the read/write device;
storing the encrypted second authentication data as new first authentication data in the identifier data store.

10. The method according to claim 9, wherein the read key is provided in the read/write device.

11. The method according to claim 1, wherein the authentication data are encrypted and said method further comprises the steps of:
generating a write key/read key pair by the read/write device;
sending the read key to the comparator;
decrypting the first authentication data in the comparator with the read key which is stored in a read key store of the comparator;
comparing the decrypted first authentication data with the comparative data and generating second authentication data if the first authentication data match the comparative data;
sending the unencrypted second authentication data to the local read/write device;
encrypting the second authentication data with the write key which is known only to the read/write device;
storing the encrypted second authentication data as new first authentication data in the identifier data store.

12. The method according to claim 1, wherein the authentication data comprise identity data which allow clear identification of the identifier, and test data, which are compared with the comparative data of the identifier, wherein new test data are provided if the identity data and the test data match the comparative data.

13. The method according to claim 12, wherein the test data are encrypted and the identity data are unencrypted.

14. The method according to claim 12, wherein the test data comprise at least one of the following data: date, position, random numbers, Unique Identification Number (UID) of the identifier data store, in particular of the RFID tag.

15. The method according to claim 1, wherein the comparator compares the first authentication data and the comparative data in the local read/write device and the comparative data are stored in an external storage device, said method further comprising the steps of:
requesting the comparative data from the external storage device by the read/write device;
sending the comparative data by the external storage device to the read/write device;
comparing the first authentication data with the sent comparative data by the comparator in the local read/write device;
providing second authentication data by the read/write device if the first authentication data match the sent comparative data;
sending the provided second authentication data to the external storage device;
storing the second authentication data as new comparative data in the comparative data store of the external storage device.

16. A system for authenticating an object, comprising:
a read/write device designed to read first authentication data from an identifier data store for an identifier, in particular for an RFID tag, and to write second authentication data into the identifier data store of the identifier;
a comparator containing a comparative data store,
wherein the system is designed to compare first authentication data with comparative data which are stored in the comparative data store, to provide second authentication data and to store them as new comparative data in the comparative data store if the first authentication data match the comparative data.

17. A local read/write device for a system for authenticating an object, comprising:
a transmitter unit for sending data;
a receiver unit for receiving data;
a reading device which is designed to read first authentication data from an identifier data store of an identifier, in particular of an RFID tag, which is attached to an object to be authenticated.
a decryption device for decrypting authentication data with a read key;
a storage device for storing a read key;
a write device for writing the second authentication data as first authentication data into the identifier store of the identifier.

18. A local read/write device for a system for authenticating an object, comprising:
a transmitter unit for sending data;
a receiver unit for receiving data;
a key generating device for generating a read key/write key pair, wherein the write key is known only to the read/write device and the read key is sent by the transmitter device to the comparator and is stored in a key storage device of the comparator;
a read device which is designed to read first authentication data from an identifier store of an identifier, in particular of an RFID tag, which is attached to an object to be authenticated;
an encryption device for encrypting the second authentication data with the write key if the first authentication data match the comparative data;
a write device for writing the second authentication data as first authentication data into the identifier store of the identifier.

19. A comparator for a system for authenticating an object, for comparing first authentication data from an identifier data store of an identifier, in particular of an RFID tag, which is attached to an object to be authenticated, with the comparative data, comprising:
a transmitter unit for sending data;
a receiver unit for receiving data;
a key generating device for generating a read key/write key pair, wherein the write key is known only to the comparator and the read key is sent by the comparator to a read/write device and is stored in a key generating device of the read/write device;
a key storage unit for storing a read key/write key pair, wherein the write key is known only to the comparator;
an authentication data generating unit for generating second authentication data;
an encryption device for encrypting the second authentication data with the write key if the first authentication data match the comparative data;
a comparative data store for storing the second authentication data as comparative data if the first authentication data match the comparative data from a comparative data store.

20. A computer program, comprising computer programming means designed to cause a system for authenticating an object according to claim 16 to execute an authentication method that includes the steps of:
reading first authentication data from an identifier data store of an identifier, in particular of an RFID tag, which is attached to the object, by a read/write device designed to read data from the identifier data store and to write data into the identifier data store;
providing comparative data in a comparative data store of a comparator;
authenticating the identifier by comparing the first authentication data with the comparative data;
generating second authentication data;
storing said second authentication data as new comparative data in the comparative data store and as new first authentication data in the identifier data store if the first authentication data match the comparative data.
